(19) United States
(12) Patent Application Publication
(10) Pub. No.: US 2026/0326113 A1
(43) Pub. Date: Oct. 22, 2026

(54) Cutting device, especially for fine grinders, continuous fine grinders, cutters and similar

(71) Applicant: Maschinenfabrik Seydelmann KG, Stuttgart (DE)

(72) Inventor: Andreas Gässler, Kirchheim (DE)

(73) Assignee: Maschinenfabrik Seydelmann KG, Stuttgart (DE)

(21) Appl. No.: 19/638,856

(22) Filed: Apr. 3, 2026

(30) Foreign Application Priority Data
Apr. 8, 2025 (DE) 20 2025 101 938.8
Apr. 10, 2025 (EP) 25 169 685.2

(51) Int. Cl. B02C 18/30; B02C 18/36

(52) U.S. Cl. CPC B02C 18/305; B02C 18/365

(57) ABSTRACT

The invention relates to a cutting device (10), especially for fine grinders, continuous fine grinders, cutters and similar, having at least one stationary perforated plate (20) which has an inner circumference (21) or an outer circumference and having a spacer ring (30) which may be detachably arranged on the inner circumference (21) or on the outer circumference of the perforated plate (20) and may be driven in a rotatable manner and which has one or more projections (31) with which it may interact with the inner circumference (21) or the outer circumference of the perforated plate (20). The invention now proposes that the perforated plate (20) has a circumferential groove (25) on its inner circumference (21) or on its outer circumference, which is formed integrally with the perforated plate (20), and that the spacer ring (30) is arranged on or in the perforated plate (20) in such a way that the projections (31) enter the groove (25) on the inner circumference or on the outer circumference of the spacer ring (30), so that the spacer ring (30) is held onto or in the perforated plate (20) while allowing it to rotate. The perforated plate (20) has at least one recess (23) and, in order to mount the spacer ring (30) on or in the perforated plate (20), the recess (23) on the perforated plate (20) is aligned with one or more of the projections (31) of the spacer ring (30). The projection (31) may be inserted into the groove (25) on the inner circumference (21) of the perforated plate (20). Alternatively, the spacer ring (30) has at least one groove (32) on each of its projections (31), while the perforated plate (20) has a circumferential rib (22) on its inner circumference (21), which is formed integrally with the perforated plate (20). The spacer ring (30) is arranged in the perforated plate (20) in such a way that the circumferential rib (22) of the perforated plate (20) enters the grooves (32) on the projections (31), so that the spacer ring (30) is held in the perforated plate (20), allowing it to rotate. The perforated plate (20) has at least one recess (23), wherein, for mounting the spacer ring (30) in the perforated plate (20), the recess (23) on the perforated plate (20) is aligned with one of the projections (36) of the spacer ring (30) and the rib (22) on the inner circumference (21) or the outer circumference of the perforated plate (20) engages in the grooves (32) of the projections (31) (FIG. 6).

The invention relates to a cutting device of the type mentioned in the general term, especially for use in a fine grinder, also known as a cutter, or a continuous fine grinder, also known as a Konti-Kutter. Such cutting devices are used especially in the meat-processing industry, but also in other areas of food preparation and grinding, especially for substances to be emulsified, such as baby food and similar, as well as in other industries.

During operation of the fine grinder or a continuous fine grinder, the substance to be ground is pressed against the cutting set, which in the case of a fine grinder consists of several fixed perforated plates and rotating perforated discs, by means of a feeding worm or another conveying mechanism, such as a vacuum. There are also fine grinders that have knives in addition to the perforated plates and perforated discs. When producing fine sausage meat, the perforated plates and perforated discs of the fine grinder must have particularly fine holes and should wear as little as possible during operation of the fine grinder.

In a conventional fine grinder, stationary perforated plates and rotating perforated discs are arranged alternately to produce sausage meat in various degrees of fineness. For this purpose, the stationary perforated plates are equipped with a spacer ring that is rotatably mounted on the perforated plate and moves with the rotating perforated discs to minimise wear and abrasion on the perforated plates and the perforated discs. On the one hand, this has the advantage that the perforated discs and perforated plates require less regrinding less frequently and, on the other hand, that less abrasion and wear of the cutting tools gets into the food where it may be processed unintentionally.

The spacer ring is rotatably mounted on the stationary perforated plate. The spacer ring may be arranged either on the inner or outer circumference of the perforated plate. The perforated plate is secured against rotational movements, for example by means of a sliding block or other suitable measures.

There are various ways of keeping the spacer ring rotatable on the perforated plate. After a certain time, however, the complete cutting set must be removed for cleaning or re-grinding. As the spacer rings are not firmly attached to the perforated plates, they may and will be inadvertently mixed up. As the spacer rings and perforated plates are matched to each other and each stationary perforated plate with its spacer ring is subjected to different utilisations, the different perforated plates also wear differently. For this reason, the respective stationary perforated plates and spacer rings are marked with a uniform, consecutive number. In practice, however, this measure is often not sufficient to prevent the stationary perforated plates and spacer rings from being mixed up. However, if a spacer ring is fitted to a different stationary perforated plate, damage or bad batches may occur during operation of the fine grinder due to excessive abrasion. The perforated plates may also be damaged and then must be replaced. This then leads to unnecessary costs and the need to procure an expensive replacement, resulting in unnecessary downtimes of the system, e.g. due to repair, replacement of the cutting set parts, etc.

Documents DE 10 2010 055 785 B4 and DE 10 2010 055 786 B4 each describe a fine grinder with a perforated disc system consisting of stationary perforated plates with a spacer ring and rotating perforated discs. The stationary perforated plates have a rotatably mounted inner ring that serves as a spacer ring to the rotating perforated discs. The stationary perforated plates and rotating perforated discs serve as cutting tools. How the spacer rings are mounted or held in place in the stationary perforated plates is not described in detail in the documents.

The purpose of the invention is therefore to avoid the above-mentioned disadvantages and to provide a cutting device on which a spacer ring may be rotatably held on a stationary perforated plate and which prevents accidental removal of the spacer ring from the stationary perforated plate. This task is solved by the characterising features of claims 1 and 2, which are of particular significance as follows.

In an initial and preferred exemplary embodiment, the spacer ring has several projections that extend in an axial direction. The stationary perforated plate has a circumferential groove on its inner circumference, which is formed integrally with the perforated plate. The groove may also be interrupted. In the assembled state, the projections on the spacer ring engage in the groove on the inner circumference of the perforated plate, whereby the spacer ring is held in the perforated plate so that it may rotate. The perforated plate features at least one recess aligned with at least one projection on the spacer ring for mounting the spacer ring to connect the two components to each other.

In a second preferred exemplary embodiment, the spacer ring also has several projections. Here, however, the projections each have a groove, while the perforated plate has a circumferential rib in the area of its inner circumference, which is formed in one piece with the perforated plate. When mounted, the spacer ring is arranged in the perforated plate in such a way that the grooves on the projections surround the rib on the inner circumference of the perforated plate. As a result, the spacer ring is held captive in the perforated plate but may be rotated. In this exemplary embodiment, the perforated plate also has a recess that is aligned with the projection to enable the spacer ring to be mounted on the perforated plate. It may be provided that one flank of the projection overcomes the rib on the perforated plate.

Of course, a kinematic reversal is also possible. In this case, the spacer ring is provided as an outer ring, which is arranged on the outer circumference of the stationary perforated plate. The spacer ring is also moved with the rotating perforated discs in this case. Here, the spacer ring may have one or more projections that engage in a groove arranged on the outer circumference of the perforated plate. In the same way, the circumferential groove may be arranged on the spacer ring, for example, on one or more projections, while the perforated plate has a rib.

In all exemplary embodiments, the spacer ring is held on the perforated plate so that it may rotate. During operation of the fine grinder, the spacer ring thus rotates while the perforated plate remains stationary in the housing of the fine grinder. The spacer ring is held on the perforated plate so that it may rotate positively and cannot be removed without tools, nor may it be refitted later.

When the spacer ring is fitted to the perforated plate, the recess and the projection are aligned with each other. In some exemplary embodiments, the spacer ring is then subjected to such a force that-depending on the exemplary embodiment-the projection on the spacer ring overcomes the side wall of the groove on the inner circumference of the perforated plate or one flank of the groove on the projection overcomes the rib on the inner circumference of the perforated plate and the spacer ring is thus held in the perforated plate. Similarly, the spacer ring is attached to the outer circumference of the perforated plate. To achieve this, you may also heat the perforated plate or the spacer ring so that it expands slightly, or cool the spacer ring or the perforated plate so that they contract. In this way, the spacer ring is held captive but detachable on the perforated plate. To remove it from the perforated plate again, the spacer ring must be realigned and subjected to a force such that the projection on the spacer ring overcomes the side wall of the groove on the inner circumference of the perforated plate or one flank of the groove on the projection overcomes the rib on the inner circumference of the perforated plate, whereby it may also be helpful here to heat the perforated plate or cool the spacer ring. If the spacer ring is arranged on the outer circumference of the perforated plate, the projections on the spacer ring or on the perforated plate must overcome a flank of the circumferential groove on the perforated plate or on the spacer ring. Here too, the components in question may be heated or cooled again. It is also possible to heat the perforated plate and cool the spacer ring at the same time to mount the spacer ring on the inner circumference of the perforated plate or to detach it from the perforated plate. The same applies in reverse when mounting or removing the spacer ring on the outer circumference of the perforated plate. This type of cooling usually takes place down to the minus range.

To simplify the assembly and disassembly of the spacer ring, the projections may be shaped as rounded tabs. It is then easy to establish and release the connection with the perforated plate, as there are no corners that could get caught.

It is particularly advantageous if the perforated plate or the spacer ring may be heated or cooled without being damaged or undergoing a structural change. In these exemplary embodiments, it is not possible to separate the spacer ring and the perforated plate from each other without considerable effort. Unintentional separation of the components from each other is impossible, so that the aforementioned problems with incorrectly assembled spacer rings on perforated discs are avoided.

In a further preferred exemplary embodiment, the projections on the spacer ring are designed as pins that engage in a groove on the perforated plate. Preferably, at least three pins with two different lengths may be provided. The two pins with the longer lengths, hereinafter referred to as bearing pins, may then be arranged diametrically opposite each other on the spacer ring. At least one further third pin, hereinafter referred to as the retaining pin, is then provided on one half of the circumference of the spacer ring and has a shorter length than the two bearing pins. A recess is provided in the perforated plate for each of these retaining pins.

In this exemplary embodiment, the spacer ring may be pivoted when mounted on the perforated plate, for example, to carry out cleaning-especially of the groove. To do this, the retaining pins must be aligned with the recesses on the perforated plate; then the spacer ring may be pivoted, as it is only held in the groove by the two bearing pins. The bearing pins act as a pivot axis. The recesses on the perforated plate may only be located on one side so that pivoting may only take place in one direction and the spacer ring cannot be pivoted through 180° in the perforated plate after the pivoting process.

At the end of the swivelling process of the cutting device, the retaining pins must be aligned with the recesses again and the cutting device may be reinstalled in the fine grinder or similar. When installing the cutting device, the bearing pins are mounted captive in the spacer ring in such a way that they protrude into the groove on the perforated plate. This may be done by tapping, screwing or by other means. To prevent the spacer ring and the perforated plate from being attached to each other rotated by 180°, two or more recesses may be provided that are arranged asymmetrically over half the inner circumference of the perforated plate and matching retaining pins on the spacer ring. When assembling the perforated plate with the spacer ring, these may then only be mounted to each other in one direction and not rotated by 180°.

Advantageously, the perforated plate has a mounting side from which the spacer ring may be mounted on the perforated plate. The rib or the side wall may then have material removed on the mounting side, such as in the form of a chamfer, bevel, rounding or similar, to make it easier for the one flank or the projection to overcome the rib or the side wall. Of course, it is also possible for the rib to have some material removed on both sides or both side walls. The mounting side may preferably be the front side of the perforated plate. Furthermore, one or more recesses may also be provided on the mounting side, into which the retaining pin or pins engage.

If the spacer ring is mounted on the perforated plate, it is advantageously held in place by a form-fitting connection and may be rotated. It cannot be fitted to or removed from the perforated plate without tools. This may prevent the spacer ring from being unintentionally removed during installation and removal, cleaning or regrinding and then being remounted on the wrong perforated plate, causing damage during operation of the fine grinder or bad batches being produced.

In a particularly advantageous exemplary embodiment, the spacer ring is a few 1/100 mm higher than the perforated plate. This allows the spacer ring of the perforated plate to be clamped between the two perforated discs when assembling the complete fine grinder cutting set, whereby the perforated plates may rotate without contact and do not touch the stationary perforated discs. The spacer ring itself may move freely in the perforated plate.

In a preferred exemplary embodiment, the spacer ring is engaged by a central shaft and driven by one or more bolts that engage through the spacer ring at bolt openings. The bolts pass through all the parts to be driven, i.e. the spacer ring as well as the adjacent rotating perforated discs. As a result, all rotating components are moved together, thus preventing any differences in movement. In a further exemplary embodiment, the bolts and also the bolt openings have at least two different diameters. These may then be arranged in such a way that there is a clear installation position and the components may not be inadvertently twisted or installed mirrored. It is also possible to provide at least one bolt with an asymmetrical cross-section to achieve an unambiguous installation position. Alternatively, a knife stud may also be used to drive the rotating components. This knife stud may also have an asymmetrical cross-section so that the cutting set may only be mounted in one direction.

Further advantages and exemplary embodiments are shown in the sub-claims, the following description as well as the drawings. The invention is illustrated in two exemplary embodiments in the figures. The following are depicted:

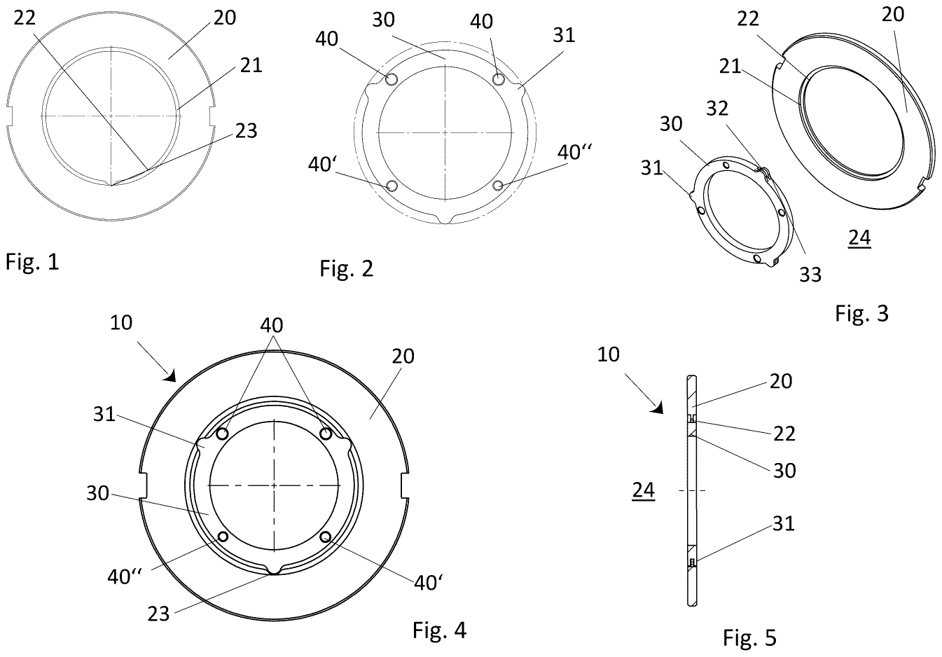

FIG. 1: Front view of a perforated plate according to a first exemplary embodiment of the invention

FIG. 2: Front view of a spacer ring according to the invention

FIG. 3: Components from FIGS. 1 and 2 before assembly, perspective view

FIG. 4: Front view of the assembled cutting device from FIGS. 1 to 2

FIG. 5: Cutting device from FIG. 4, sectional view

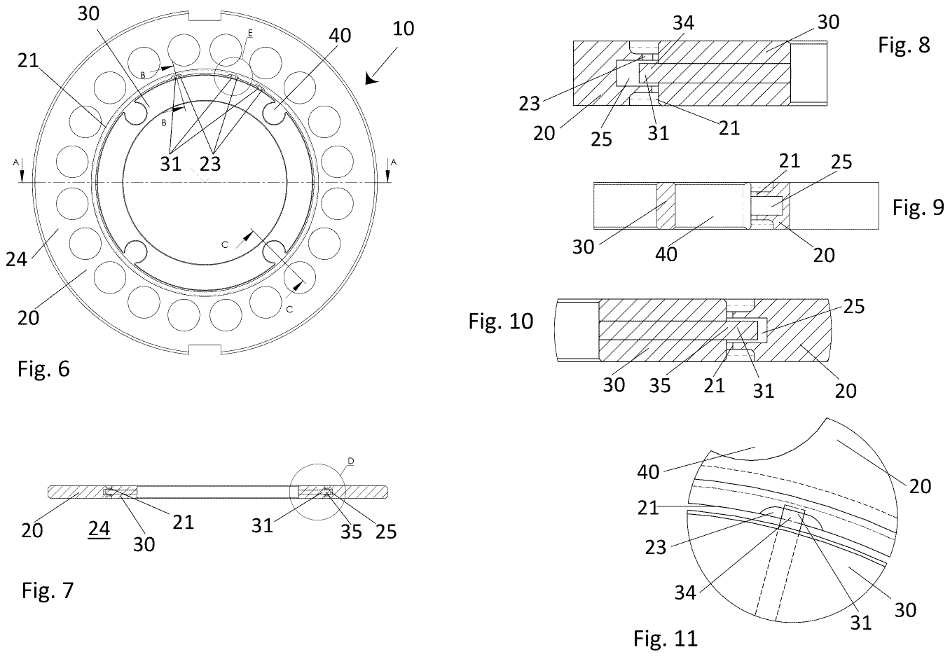

FIG. 6: Front view of a cutting device according to the invention in accordance with a second exemplary embodiment

FIG. 7: Cutting device according to FIG. 6 along the section A-A in FIG. 6

FIG. 8: Cutting device according to FIGS. 6 and 7 along section B-B in FIG. 6

FIG. 9: Cutting device according to FIGS. 6 to 8 along section C-C in FIG. 6

FIG. 10: Magnification D of the cutting device according to FIGS. 6 to 9 in FIG. 7

FIG. 11: Magnification E of the cutting device according to FIGS. 6 to 10 in FIG. 6

FIG. 1 shows a perforated plate 20 according to the invention. This plate has a large number of openings across its surface, although these are not shown here. The openings may vary in size, number and shape depending on the application. Round, oval or kidney-shaped openings have proven to be suitable. The edges of the openings in the stationary perforated plate 20 together with the edges of the openings in the rotating perforated discs form the cutting tool.

A circumferential rib 22 may be seen on the inner circumference 21 of the perforated plate 20. This rib has a recess 23, which may be used to mount the spacer ring 30 on the perforated plate 20. The associated perforated plate 20 is shown in FIG. 2. This plate has three projections 31 designed as rounded tabs, which are arranged at an angle of approx. 120° from each other on the outer circumference of the spacer ring 21. Furthermore, four bolt openings 40, 40′, 40″ are depicted, which have three different diameters so that the spacer ring 21 may only be installed in a fixed orientation.

The perspective view in FIG. 3 shows the groove 32 on the projections 31 on the spacer ring 30. The side of the projection 31 facing the mounting side 24 of the perforated plate 20 has a flank 33, which overcomes the rib 22 in the area of the recess 23 to bring about the assembled state of the cutting device 10.

FIGS. 4 and 5 show this assembled state. The spacer ring 30 is held in the perforated plate 30. The projections 31 of the spacer ring 30 engage with their grooves 32 around the circumferential rib 22 on the inner circumference 21 of the perforated plate 20. The spacer ring 30 is held freely rotatable in the perforated plate 20 and cannot be disassembled without the aid of tools, so that accidental loss or reassembly with the wrong perforated plate is practically impossible.

FIGS. 6 to 11 depict a further exemplary embodiment. Here too, the spacer ring 30 is rotatably mounted on the inner circumference 21 of the perforated plate 20. In this example, the perforated plate 20 has round, relatively large holes. However, as already explained, these may also be designed differently, arranged differently and also provided in different numbers. The spacer ring 30 is also driven here via bolts that engage in the four bolt openings 40 shown.

The perforated plate 20 has a circumferential groove 25 on its inner circumference. Two bearing pins 35 and three retaining pins 34 engage in these. The bearing pins 35 are particularly recognisable in FIGS. 7 and 10 and have a greater length than the retaining pins so that they cannot be unintentionally brought out of the groove 25 at the recesses 23 on the perforated plate 20.

The retaining pins 34 are clearly recognisable in FIGS. 6, 8 and 11. They have a shorter length than the bearing pins 35 and may be removed from the groove 25 by means of the recesses 23 to swivel the spacer ring 30 within the perforated plate 20. The spacer ring 30 is still held rotatably in the groove 25 by the two bearing pins 35.

To prevent the spacer ring 30 from being mounted rotated by 180° in the perforated plate 20 after pivoting, the recesses 23 are provided on only one side, namely the mounting side 24 of the perforated plate 20. This prevents the spacer ring 30 from being inserted into the perforated plate 20 rotated by 180° after cleaning or maintenance. This could again lead to problems described above with bad batches and damage to the components.

The bearing pins 35 and retaining pins 34 are the only projections 31 that engage in the groove 25 in the perforated plate 20. This may also be seen in FIG. 9. As a result, the spacer ring 30 is mounted in the perforated plate 30 in a rotatable and captive manner.

Finally, it should be pointed out that the exemplary embodiments shown here are merely exemplary implementations of the invention. These exemplary embodiments are not limited to this. Rather, changes and modifications are still possible. For example, the spacer ring may have more or fewer bolt openings. The design of the holes in the perforated plate may also vary. Furthermore, the rib or the groove on the perforated plate may be interrupted or be present in several sections. The exact design depends on the particular application. There may also be a circumferential groove on the spacer ring, while the stationary perforated plate has one or more projections on its inner or outer circumference that may interact with this groove. Furthermore, one or more projections may also be arranged on the stationary perforated plate as a kinematic reversal of the described exemplary embodiments.

### LIST OF REFERENCE NUMBERS

10 Cutting device
20 Perforated plate
21 Inner circumference of
22 Rib at 21
23 Recess at 20
24 Mounting side of 20
25 Groove in 21
30 Spacer ring
31 Projection
32 Groove
33 A flank from 31
34 Retaining pins
35 Bearing pins
40 Bolt opening
40′ Bolt opening
40″ Bolt opening

1. A cutting device, especially for fine grinders, continuous fine grinders, cutters and similar, with at least one stationary perforated plate (20) with an inner circumference (21) and with a spacer ring (30) that may be detachably arranged on the inner circumference of the perforated plate (20) and may be driven in a rotatable manner, having one or more projections (31) with which to interact with the inner circumference (21) of the perforated plate (20),
characterised
in that the perforated plate (20) has a circumferential groove (25) on its inner circumference (21), which is formed in one piece with the perforated plate (20),
and in that the spacer ring (30) is arranged in the perforated plate (20) in such a way that the projections (31) enter the groove (25) on the inner circumference of the spacer ring (30), so that the spacer ring (30) is held in the perforated plate (20), allowing it to rotate,
in that the perforated plate (20) has at least one recess (23) and in that, for mounting the spacer ring (30) in the perforated plate (20), the recess (23) on the perforated plate (20) is aligned with one or more of the projections (31) of the spacer ring (30) and the projection (31) may be inserted into the groove (25) on the inner circumference (21) of the perforated plate (20),
or
in that the spacer ring (30) has at least one groove (32) on each of its projections (31),
that the perforated plate (20) has a circumferential rib (22) on its inner circumference (21), which is formed integrally with the perforated plate (20),
and in that the spacer ring (30) is arranged in the perforated plate (20) in such a way that the circumferential rib (22) of the perforated plate (20) enter the grooves (32) on the projections (31), so that the spacer ring (30) is held in the perforated plate (20), allowing it to rotate,
in that the perforated plate (20) has at least one recess (23) and in that, for mounting the spacer ring (30) in the perforated plate (20), the recess (23) on the perforated plate (20) is aligned with one of the projections (36) of the spacer ring (30) and the rib (22) on the inner circumference (21) of the perforated plate (20) enter the grooves (32) of the projections (31).

2. A cutting device (10), especially for fine grinders, continuous fine grinders, cutters and similar, with at least one stationary perforated plate (20), which has an outer circumference and with a spacer ring that can be detachably arranged on the outer circumference of the perforated plate (20) and can be driven in a rotary manner, which has one or more projections (31) with which it can interact with the outer circumference of the perforated plate (20),
characterised
in that the perforated plate (20) has a circumferential groove on its outer circumference, which is formed integrally with the perforated plate (20),
and in that the spacer ring is arranged on the perforated plate (20) in such a way that the projections (31) enter the groove on the outer circumference of the spacer ring, so that the spacer ring is held on the perforated plate (20) allowing it to rotate,
in that the perforated plate (20) has at least one recess (23) and that, in order to mount the spacer ring on the perforated plate (20), the recess (23) on the perforated plate (20) is aligned with one or more of the projections of the spacer ring
and in that the projection may be inserted into the groove on the outer circumference (21) of the perforated plate (20),
or
in that the spacer ring has at least one groove on each of its projections,
in that the perforated plate (20) has a circumferential rib (22) on its outer circumference, which is formed integrally with the perforated plate (20),
and in that the spacer ring is arranged on the perforated plate (20) in such a way that the circumferential rib (22) of the perforated plate (20) enters the grooves on the projections, so that the spacer ring is held on the perforated plate (20), allowing it to rotate,
in that the perforated plate (20) has at least one recess (23) and in that, for mounting the spacer ring on the perforated plate (20), the recess (23) on the perforated plate (20) is aligned with one of the projections of the spacer ring and the rib (22) on the outer circumference of the perforated plate (20) enters the grooves (32) of the projections.

3. The cutting device (10) according to claim 1, characterised in that the projection or projections (31) are designed as pins (34, 35).

4. The cutting device (10) according to claim 3, characterised in that at least three pins (34, 35) are provided, which have at least two different lengths, namely bearing pins (35) and holding pins (34).

5. The cutting device (10) according to claim 4, characterised in that at least one retaining pin (34) may be aligned with at least one of the recesses (23) in the perforated plate (20), while two bearing pins (35) engage diametrically opposite one another in the groove (25) on the perforated plate (20).

6. The cutting device (10) according to claim 5, characterised in that a plurality of recesses (23) are provided which are distributed asymmetrically over the inner circumference (21) of the perforated plate (20) and in that there are just as many retaining pins (34) which are provided on the spacer ring (30) to match.

7. The cutting device (10) according to claim 1, characterised in that when one of the projections (31) is introduced into a groove (25), the projection (31) overcomes a side wall of the groove (25) or that when the rib (22) is inserted into a groove (32), a flank (33) of the projection (31) overcomes the rib (22) on the perforated plate (20).

8. The cutting device (10) according to claim 1, characterised in that the spacer ring (30) is a few 1/100 mm higher than the perforated plate (20).

9. The cutting device (10) according to claim 1, characterised in that the spacer ring (30) is penetrated by a central shaft and is driven by means of several bolts which penetrate the spacer ring (30) at bolt openings (40, 40′, 40″).

10. The cutting device (10) according to claim 1, characterised in that the spacer ring (30) and/or the rotating perforated discs are penetrated by a knife stud and driven via this stud.

11. The cutting device (10) according to claim 9, characterised in that the bolt openings (40, 40′, 40″) have at least two different diameters and/or in that at least one of the bolts has an asymmetrical cross-section or in that the knife stud has an asymmetrical cross-section.

12. The cutting device (10) according to claim 1, characterised in that, when the spacer ring (30) is in the assembled state, it is held in a rotatable manner on the perforated plate (20) by means of a form-fitting connection, and in that the spacer ring (30) cannot be inserted into and/or removed from the perforated plate (20) without tools.

13. The cutting device (10) according to claim 1, characterised in that, for mounting the spacer ring (30) on the inner circumference of the perforated plate (20), the perforated plate (20) is heated and thus enlarged, or in that, for mounting the spacer ring (30) on the outer circumference of the perforated plate (20), the spacer ring is heated and thus enlarged and then the spacer ring (30) may be mounted on the perforated plate (20) by applying force.

14. The cutting device (10) according to claim 1, characterised in that, for mounting the spacer ring (30) on the inner circumference of the perforated plate (20), the spacer ring (30) is cooled and thus reduced in size, or in that, for mounting the spacer ring (30) on the outer circumference of the perforated plate (20), the perforated plate (20) is cooled and thus reduced in size and then the spacer ring (30) may be mounted on the perforated plate (20) by applying force.

15. The cutting device (10) according to claim 1, characterised in that the perforated plate (20) has a mounting side (24) from which the spacer ring (30) may be mounted in the perforated plate (20).

16. The cutting device (10) according to claim 15, characterised in that the rib (22) on the mounting side (24) has material removed in the form of a chamfer, bevel, rounding or similar.

17. The cutting device (10) according to claim 1, characterised in that the projections (31) are designed as rounded tabs.

18. The cutting device (10) according to claim 2, characterised in that when one of the projections (31) is introduced into a groove (25), the projection (31) overcomes a side wall of the groove (25) or that when the rib (22) is inserted into a groove (32), a flank (33) of the projection (31) overcomes the rib (22) on the perforated plate (20).

19. The cutting device (10) according to claim 2, characterised in that the spacer ring (30) is a few 1/100 mm higher than the perforated plate (20).

20. The cutting device (10) according to claim 2, characterised in that the spacer ring (30) is penetrated by a central shaft and is driven by means of several bolts which penetrate the spacer ring (30) at bolt openings (40, 40′, 40″).

21. The cutting device (10) according to claim 2, characterised in that the spacer ring (30) and/or the rotating perforated discs are penetrated by a knife stud and driven via this stud.

22. The cutting device (10) according to claim 20, characterised in that the bolt openings (40, 40′, 40″) have at least two different diameters and/or in that at least one of the bolts has an asymmetrical cross-section or in that the knife stud has an asymmetrical cross-section.

23. The cutting device (10) according to claim 2, characterised in that, when the spacer ring (30) is in the assembled state, it is held in a rotatable manner on the perforated plate (20) by means of a form-fitting connection, and in that the spacer ring (30) cannot be inserted into and/or removed from the perforated plate (20) without tools.

24. The cutting device (10) according to claim 2, characterised in that, for mounting the spacer ring (30) on the inner circumference of the perforated plate (20), the perforated plate (20) is heated and thus enlarged, or in that, for mounting the spacer ring (30) on the outer circumference of the perforated plate

(20) the spacer ring is heated and thus enlarged and then the spacer ring (30) may be mounted on the perforated plate (20) by applying force.

25. The cutting device (10) according to claim 2, characterised in that, for mounting the spacer ring (30) on the inner circumference of the perforated plate (20), the spacer ring (30) is cooled and thus reduced in size, or in that, for mounting the spacer ring (30) on the outer circumference of the perforated plate (20), the perforated plate (20) is cooled and thus reduced in size and then the spacer ring (30) may be mounted on the perforated plate (20) by applying force.

26. The cutting device (10) according to claim 2, characterised in that the perforated plate (20) has a mounting side (24) from which the spacer ring (30) may be mounted in the perforated plate (20).

27. The cutting device (10) according to claim 26, characterised in that the rib (22) on the mounting side (24) has material removed in the form of a chamfer, bevel, rounding or similar.

28. The cutting device (10) according to claim 2, characterised in that the projections (31) are designed as rounded tabs.
